(19) United States
(12) Patent Application Publication
(10) Pub. No.: US 2024/0142116 A1
(43) Pub. Date: May 2, 2024

(54) HEAT PUMP WITH SOLAR HEATING AND RADIATIVE COOLING

(71) Applicant: TRANE INTERNATIONAL INC., Davidson, NC (US)

(72) Inventors: Zubin Varghese, Bangalore (IN); Balegundi L. Rohith, Bangalore (IN); Jeyaprakash Gurusamy, Bangalore (IN); Ayush Varshney, Bangalore (IN)

(21) Appl. No.: 18/495,980

(22) Filed: Oct. 27, 2023

(30) Foreign Application Priority Data
Oct. 28, 2022 (IN) 202241061612

(51) Int. Cl. F24D 19/10; F24D 3/00; F24D 3/18

(52) U.S. Cl. CPC F24D 19/1045; F24D 3/005; F24D 3/18; F24D 2200/123; F24D 2200/14; F24D 2220/042

(57) ABSTRACT

Water-source heat pump systems include a solar heater to supplement heating operations and a radiative cooler such as one or more radiative cooling panels to allow the system to reject heat. The system can be controlled based on a target temperature, a current temperature, and temperatures at one or both of the solar heater and/or the radiative cooler, selecting a mechanical cooling mode, a hybrid cooling mode, a free cooling mode, a hybrid heating mode, or a free heating mode based on the temperatures.

### FIELD

This disclosure is directed to heating, ventilation, air conditioning, and refrigeration (HVACR) systems including a heat pump with a solar heater and radiative cooler, and systems and methods for control thereof.

### BACKGROUND

Cooling towers are often used to allow heat pump systems to reject heat. However, the cooling towers lose water due to evaporation. Further, the cooling towers experience water loss and further can contribute to urban heat island effects, causing local ambient temperature and humidity to rise. Heat pump systems can include a boiler to support heating operations. Reliance on such a boiler can generate greenhouse gas emissions.

### SUMMARY

This disclosure is directed to heating, ventilation, air conditioning, and refrigeration (HVACR) systems including a heat pump with a solar heater and radiative cooler, and systems and methods for control thereof.

By incorporating a solar heating unit, reliance on boilers and thus generation of emissions can be reduced or eliminated. Further, by incorporating radiative cooling elements, cooling towers can be removed for the system of the reliance on cooling towers can be reduced, thus reducing the urban heat island effect and improving the efficiency of cooling for surrounding areas, reducing environmental and energy cost impacts of cooling the conditioned space.

In an embodiment, a heat pump system includes a working fluid circuit. The working fluid circuit includes a compressor, a first heat exchanger, an expander, and a second heat exchanger. The heat pump system further includes a solar heater, a radiative cooler, a process fluid economizer, and a controller. The controller is configured to determine an operating mode of the heat pump system, based on a temperature request, a current temperature, and one or both of a temperature of the process fluid at the solar heater and a temperature of the process fluid at the radiative cooler, and to operate the heat pump system in the determined operating mode. The operating mode is selected from a set of operating modes including a mechanical cooling mode wherein the working fluid circuit is operated to provide cooling at the second heat exchanger and wherein a process fluid absorbs heat at the first heat exchanger and rejects heat at the radiative cooler. The set of operating modes further includes a hybrid cooling mode wherein the working fluid circuit is operated to provide cooling at the second heat exchanger and wherein the process fluid absorbs heat at the first heat exchanger and rejects heat at the radiative cooler and at a cooling tower. The set of operating modes further includes a free cooling mode wherein the radiative cooler provides cooled process fluid to the process fluid economizer. The set of operating modes further includes a hybrid heating mode wherein the working circuit is operated to provide heating at the second heat exchanger and wherein the process fluid absorbs heat at the solar heater and rejects heat at the first heat exchanger. The set of operating modes also includes a free heating mode wherein the solar heater provides heated process fluid to the process fluid economizer.

In an embodiment, the cooling tower is configured to receive the process fluid from the radiative cooler.

In an embodiment, the system further includes a boiler configured to receive process fluid from the solar heater, and wherein the hybrid heating mode includes operating the boiler to increase a temperature of the process fluid.

In an embodiment, the controller is configured to determine the operating mode to be the mechanical cooling mode when the temperature request is less than the current temperature, and the temperature of the process fluid at the radiative cooler is greater than the temperature request. In an embodiment, the controller is configured to determine the operating mode to be the hybrid cooling mode when the temperature request remains less than the current temperature following operation in the free cooling mode. In an embodiment, the controller is configured to determine the operating mode to be the free cooling mode when the temperature request is less than the current temperature, and the temperature of the process fluid at the radiative cooler is less than the temperature request. In an embodiment, the controller is configured to determine the operating mode to be the hybrid heating mode when the temperature request is greater than the current temperature, and the temperature of the process fluid at the solar heater is less than the temperature request. In an embodiment, the controller is configured to determine the operating mode to be the free heating mode when the temperature request is greater than the current temperature, and the temperature of the process fluid at the solar heater is greater than the temperature request.

In an embodiment, a method for operating a heat pump system includes obtaining a temperature request, obtaining a current temperature, and obtaining at least one of a temperature of a process fluid at a solar heater and a temperature of the process fluid at a radiative cooler. The method further includes determining an operating mode of the heat pump system based on the temperature request, the current temperature, and the at least one of the temperature of the process fluid at the solar heater and the temperature of the process fluid at the radiative cooler and operating the heat pump system in the determined operating mode. The operating mode is selected from a set of operating modes including a mechanical cooling mode wherein the working fluid circuit is operated to provide cooling at the second heat exchanger and wherein a process fluid absorbs heat at the first heat exchanger and rejects heat at the radiative cooler. The set of operating modes further includes a hybrid cooling mode wherein the working fluid circuit is operated to provide cooling at the second heat exchanger and wherein a process fluid absorbs heat at the first heat exchanger and rejects heat at the radiative cooler and at a cooling tower. The set of operating modes further includes a free cooling mode wherein the radiative cooler provides cooled process fluid to the process fluid economizer. The set of operating modes further includes a hybrid heating mode wherein the working circuit is operated to provide heating at the second heat exchanger and wherein the process fluid absorbs heat at the solar heater and rejects heat at the first heat exchanger. The set of operating modes also includes a free heating mode wherein the solar heater provides heated process fluid to the process fluid economizer.

In an embodiment, the operating mode is determined to be the mechanical cooling mode when the temperature request is less than the current temperature, and the temperature of the process fluid at the radiative cooler is greater than the temperature request. In an embodiment, the operating mode is determined to be the hybrid cooling mode when the temperature request remains less than the current temperature following operation in the free cooling mode. In an embodiment, the operating mode is determined to be the free cooling mode when the temperature request is less than the current temperature, and the temperature of the process fluid at the radiative cooler is less than the temperature request. In an embodiment, the operating mode is determined to be the hybrid heating mode when the temperature request is greater than the current temperature, and the temperature of the process fluid at the solar heater is less than the temperature request. In an embodiment, the operating mode is determined to be the free heating mode when the temperature request is greater than the current temperature, and the temperature of the process fluid at the solar heater is greater than the temperature request.

### DRAWINGS

FIG. 1 shows a schematic of a heat pump system according to an embodiment.

FIG. 2A shows a schematic of a heat pump system in a mechanical cooling mode.

FIG. 2B shows a schematic of the heat pump system in a hybrid cooling mode.

FIG. 2C shows a schematic of the heat pump system in a free cooling mode.

FIG. 2D shows a schematic of the heat pump system in a hybrid heating mode.

FIG. 2E shows a schematic of the heat pump system in a free heating mode.

FIG. 3 shows a flowchart of a method for determining an operating mode of a heat pump system according to an embodiment.

### DETAILED DESCRIPTION

This disclosure is directed to heating, ventilation, air conditioning, and refrigeration (HVACR) systems including a heat exchanger affecting temperature of suction gas.

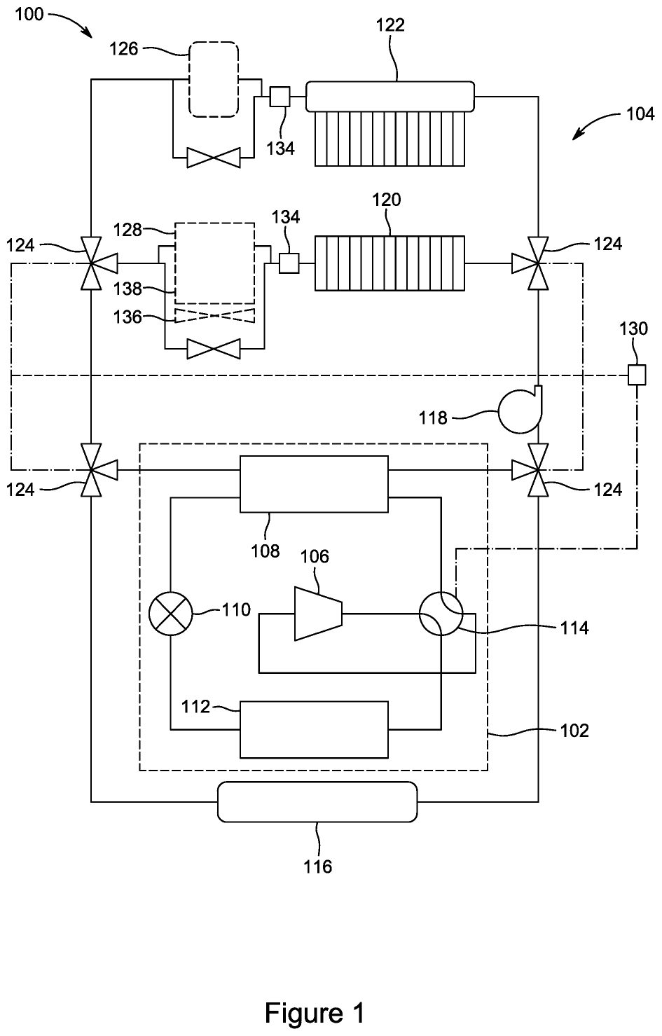

FIG. 1 shows a schematic of a heat pump system according to an embodiment. Heat pump system 100 includes working fluid circuit 102 and process fluid circuit 104. Working fluid circuit 102 includes a compressor 106, a first heat exchanger 108, an expander 110, and a second heat exchanger 112. A flow reverser 114 can also be included in working fluid circuit 102. Process fluid circuit 104 includes process fluid economizer 116, pump 118, radiative cooler 120, solar heater 122, control valves 124. Process fluid circuit 104 can optionally further include a boiler 126 and/or a cooling tower 128.

Heat pump system 100 can be, for example, a fluid source heat pump system, such as a water source heat pump system as one example, used to provide heating and cooling to one or more conditioned spaces. The heat pump system 100 can include a working fluid circuit 102 configured to circulate a working fluid and process circuit 104 configured to circulate a process fluid.

Working fluid circuit 102 is configured to provide hybrid heating and cooling in heat pump system 100. Working fluid circuit 102 can circulate a working fluid. The working fluid can be any suitable working fluid such as any refrigerant. Working fluid circuit 102 includes compressor 106. Compressor 106 can be any suitable compressor for compressing the working fluid circulated in the working fluid circuit 102, such as but not limited to a scroll, screw, or centrifugal compressor.

Working fluid circuit 102 further includes a first heat exchanger 108, configured to exchange heat between the working fluid of working fluid circuit 102 and the process fluid of process fluid circuit 104. In an embodiment, the first heat exchanger 108 can be operated as either a condenser or an evaporator depending on a direction of flow through working fluid circuit 102. In an embodiment, first heat exchanger 108 is operated as a condenser when working fluid circuit 102 is operated to provide mechanical or hybrid cooling, receiving hot working fluid from compressor 106 and rejecting heat from the working fluid to the process fluid of process fluid circuit 104. In an embodiment, first heat exchanger 108 is operated as an evaporator when the working fluid circuit 102 is operated in a hybrid heating mode, receiving cool working fluid from the expander 110, with the working fluid absorbing heat from the process fluid before passing to the suction of compressor 102.

Working fluid circuit 102 includes expander 110. Expander 110 is positioned between first heat exchanger 108 and second heat exchanger 112 with respect to flows of working fluid through the working fluid circuit 102. Expander 110 can be any suitable device for lowering a pressure of the working fluid as it passes through to expand said working fluid. Expander 110 can include, as non-limiting examples, one or more expansion valves, one or more expander plates, one or more expansion orifices, one or more expansion vessels, combinations thereof, and the like.

Working fluid circuit further includes a second heat exchanger 112 configured to provide heating or cooling to the conditioned space. The second heat exchanger 112 can provide the heating or cooling directly to the conditioned space by exchanging heat with air in or being provided to the conditioned space or zones thereof. In an embodiment, second heat exchanger 112 can be operated as either a condenser or an evaporator depending on a direction of flow through working fluid circuit 102. In an embodiment, second heat exchanger 112 is operated as an evaporator when working fluid circuit 102 is operated to provide mechanical or hybrid cooling, receiving relatively cool working fluid from expander 110 and absorbing heat, thus providing cooling to the conditioned space. In an embodiment, first heat exchanger 108 is operated as a condenser when the working fluid circuit 102 is operated in a hybrid heating mode, receiving hot working fluid from the compressor 106, with the working fluid providing heat used to heat the conditioned space.

Flow reverser 114 can be included in working fluid circuit 102. Flow reverser 114 can be configured to control a direction of flow through the working fluid circuit, such that the working fluid discharged from compressor 106 passes to one of first heat exchanger 108 and second heat exchanger 112, which is serving as a condenser, and that the other of first heat exchanger 108 and second heat exchanger 112 serves as an evaporator, flow from which passes to the suction of the compressor 106. In an embodiment, the flow reverser 114 is a four-way valve. In embodiments, flow reverser 114 can be replaced with any other suitable arrangement of valves and/or piping allowing the working fluid circuit to operate in heating and cooling modes.

Process fluid circuit 104 is configured to circulate a process fluid. The process fluid can be any suitable fluid that can provide a heat exchange medium, with non-limiting examples being water, glycol, mixtures thereof, and the like. The process fluid circuit 104 is configured to provide a source, such as water or another suitable process fluid, that can absorb heat from or provide heat to the working fluid circuit 102 by heat exchange at first heat exchanger 108. The process fluid circuit is configured to further be capable of providing heating and cooling to the conditioned space by way of process fluid economizer 116. Process fluid economizer 116 is configured to allow the process fluid to exchange heat to provide heating or cooling to the conditioned space, either directly by exchanging heat with air in, or being provided to, the conditioned space or zones thereof.

One or more pumps 118 can be included in process fluid circuit 104 to circulate the process fluid. The pumps 118 can be provided at any suitable position along fluid circuit 104 such that the process can be circulated in any operating mode of the heat pump system 100. Pumps 118 can be any suitable number and arrangement of pumps, such as a single pump, multiple pumps directly in series, multiple pumps in parallel

Radiative cooler 120 is configured to cool the process fluid by allowing the radiation of heat from said process fluid to deep space, thereby cooling the process fluid at radiative cooler 120. The radiative cooler 120 can include one or more panels. Radiative cooler 120 can include any suitable materials to provide sufficient thermal emittance and to reduce solar heating effects such that radiative cooler 120 can be used in daytime as well as nighttime conditions. For example, the radiative cooler 120 can include materials having a thermal emittance of at or about 100 to at or about 300 watts (W) per meter (m)² at an ambient temperature of at or about 25° Celsius. A surface area of the radiative cooler 120 can be any suitable size based on the available space, the size or capacity of heat pump system 100, or the like. In an embodiment, the surface area of the radiative cooler 120 can be in the range from at or about 2 m² to at or about 40 m² In an embodiment, radiative cooler 120 can include one or more sensors, such as for example but not limited to one or more temperature sensors 134 to detect temperatures within or directly following the radiative cooler 120.

Solar heater 122 is configured to heat process fluid by absorbing solar energy. The solar heater can include one or more panels configured to absorb solar energy. Solar heater 122 can further include a reservoir configured to accommodate at least some heated process fluid. Heat from the absorbed solar energy can be transferred to the process fluid either directly, by passing process fluid through the one or more panels, or by passing a heating fluid through the one or more panels and transferring heat from the heating fluid to the process fluid. In an embodiment, the heating fluid can exchange heat with the process fluid by way of a heat exchanger disposed within the reservoir. In an embodiment, one or more sensors, such as for example but not limited to temperature sensors 134, can be provided at or following solar heater 122 to detect temperature within or directly following the solar heater 122, for example within the reservoir.

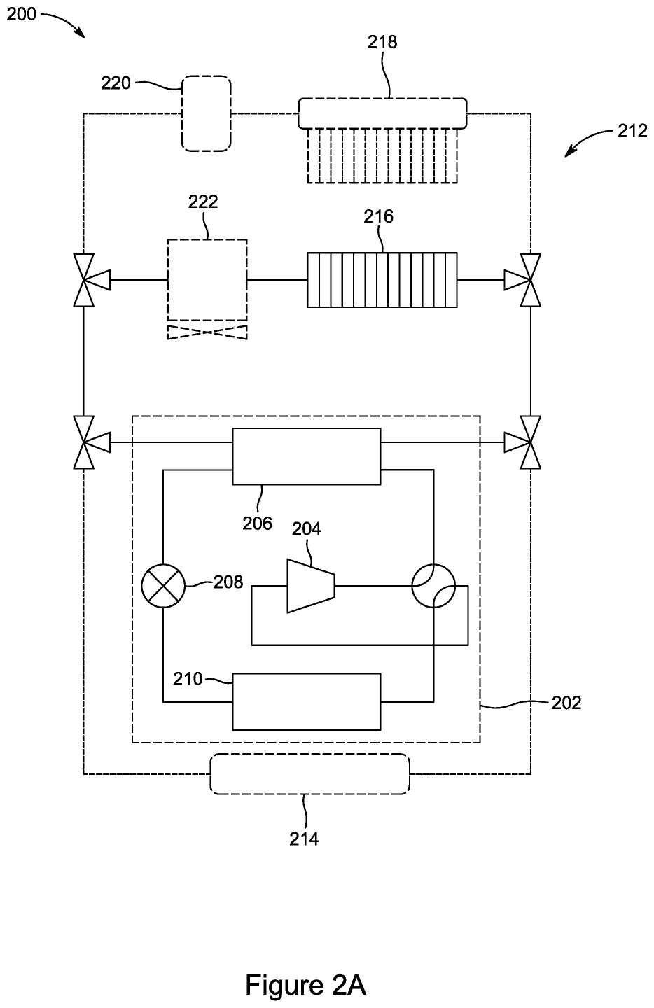

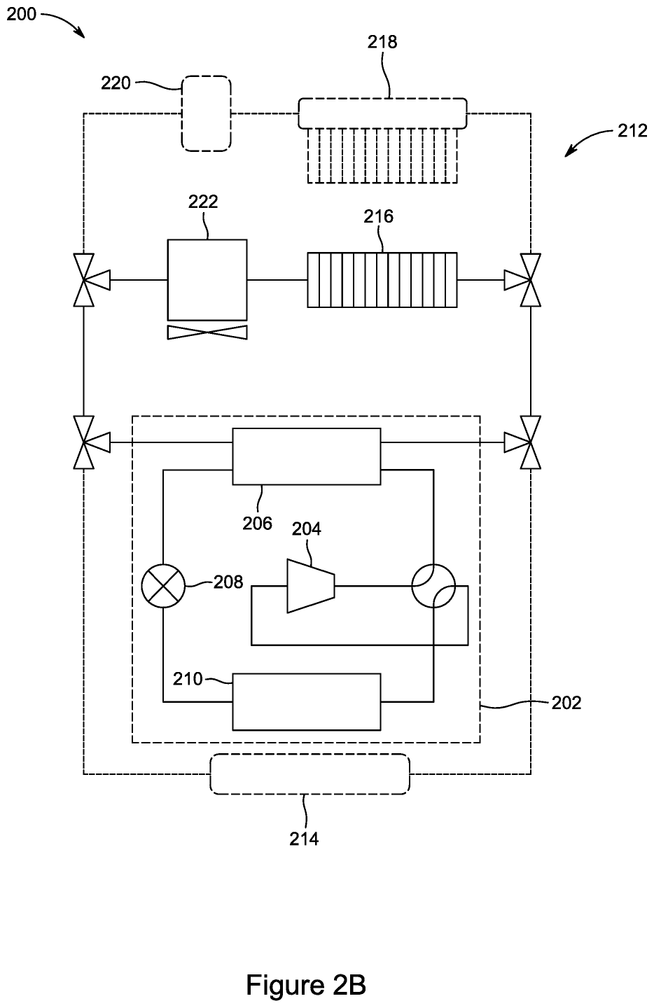

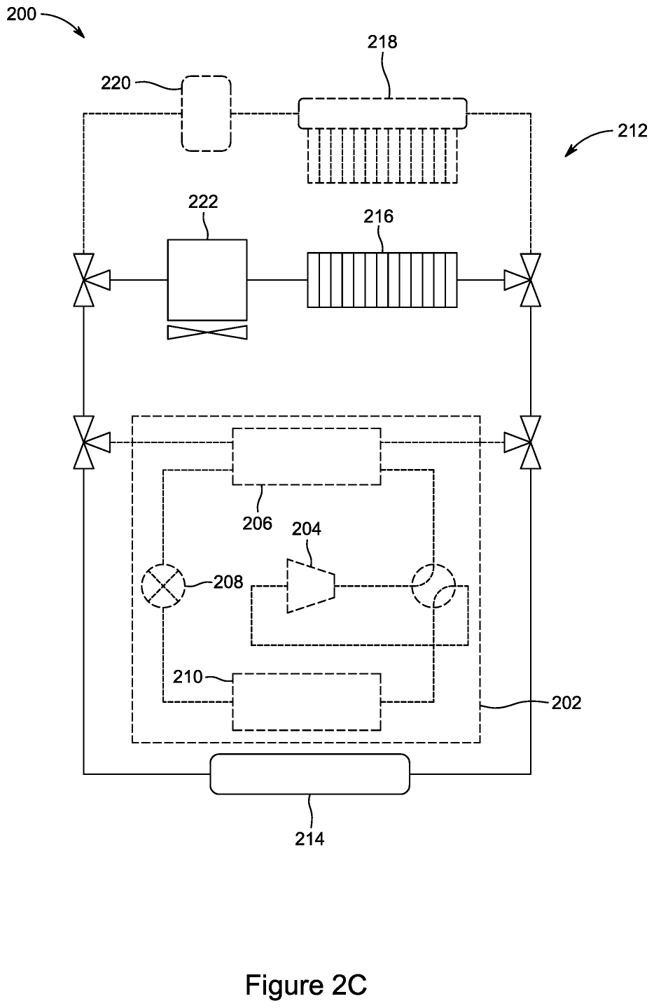

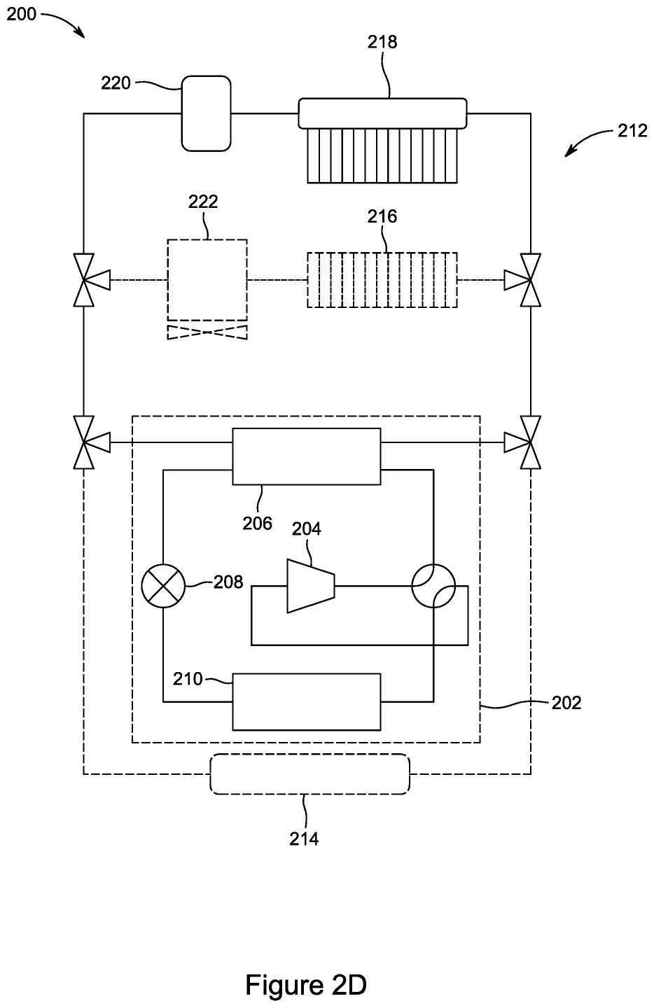

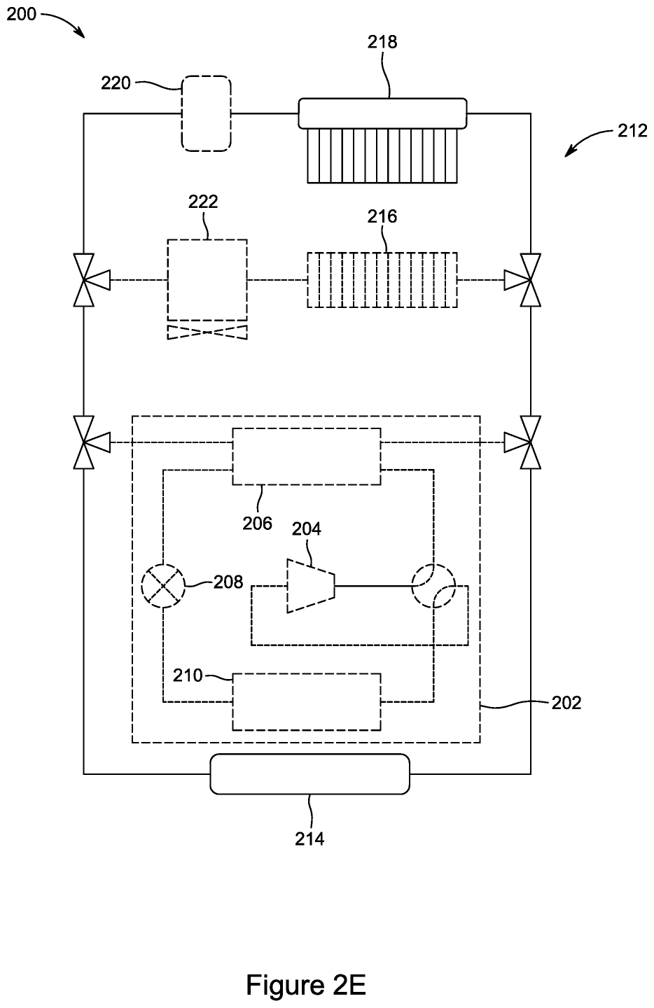

Control valves 124 can be provided along the process fluid circuit 104 such that each of the process fluid economizer 116, radiative cooler 120, solar heater 122, boiler 126, or cooling tower 128 can be selectively included in or bypassed by the process fluid circuit 104. Control valves 124 can be connected to controller 130 and each can be operated such that the process fluid circuit includes the necessary components for the current operating mode and excludes other components, in accordance with the operating modes discussed below and shown in FIGS. 2A-2F.

Boiler 126 can optionally be included to support heating operation of the heat pump system 100. Boiler 126 can be any suitable heater for adding heat to the process fluid in process fluid circuit 104. Non-limiting examples of boiler 126 include gas or oil-fueled boilers, electric heaters, or the like. The boiler 126 can be included in series with the solar heater 122. In an embodiment, the boiler 126 is downstream of solar heater 120 with respect to a flow of the working fluid when working fluid circuit 104 is in a hybrid heating mode. The boiler 126 can provide heating to supplement heating at the solar heater 122 to bring the process fluid to a desired temperature for supplying heat to the working fluid circuit 102 by way of first heat exchanger 108, and/or to provide heating by way of relatively hot process fluid at process fluid economizer 116.

Cooling tower 128 can be included to supplement cooling at radiative cooler 120. The cooling tower 128 can be a tower including a fan 136 and a sump 138, and the evaporation from the sump 138 can be used to cool the process fluid. Cooling tower 128 can be positioned in series with radiative cooler 120. In an embodiment, cooling tower 128 is downstream of radiative cooler 120 with respect to the flow of the process fluid, such that cooling tower 128 further cools process fluid after initial cooling at the radiative cooler 120. In an embodiment, when cooling tower 128 is included, control valves 124 can be provided such that cooling tower 128 can be selectively included in or bypassed by the process fluid circuit 104.

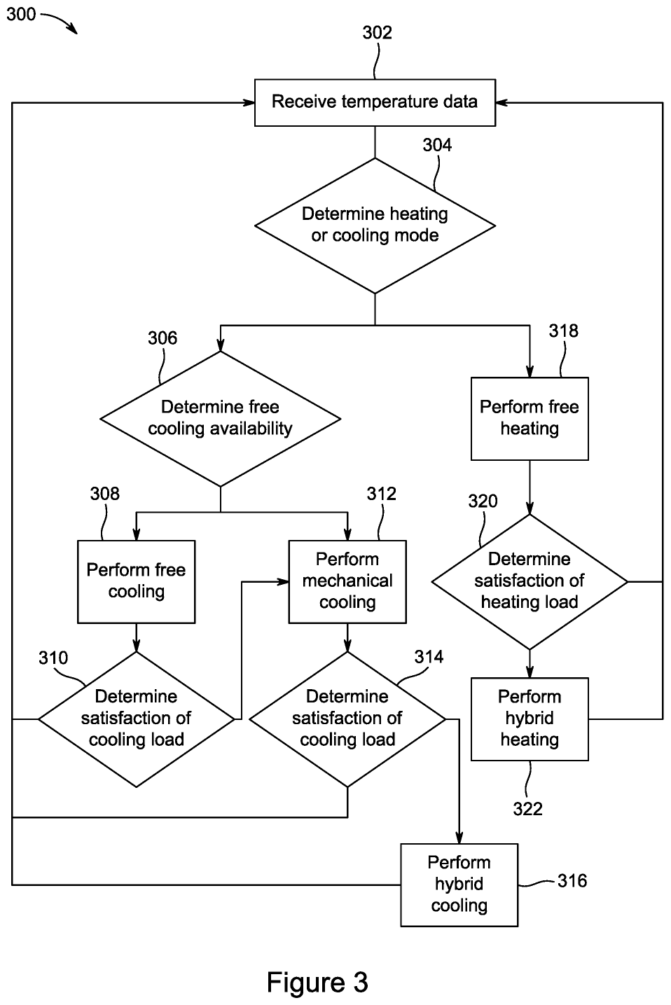

Controller 130 can be used to control the operation of heat pump system 100. Controller 130 can be configured to receive inputs from temperature sensors 134, thermostats, humidity sensors, and any other suitable input for determining the operating mode and carrying out operations of the heat pump system 100. The controller 130 can be connected to control valves 124, pump 118, compressor 106, expander 112, flow reverser 114, and/or any other suitable control points included in the heat pump system 100. Controller 130 can be configured to determine the operating mode of the heat pump system 100 based on temperatures in the conditioned space, at one or both of radiative cooler 120 and solar heater 122, and optionally further based on ambient temperatures, humidity in the conditioned space, and the like. The control can be selection of a heating or cooling mode, and a utilization of working fluid circuit 102, radiative cooler 120, solar heater 122, boiler 126, and/or optional cooling tower 128 to perform said heating or cooling mode. An example of a method for determining an operating mode for the heat pump system is provided in FIG. 3 and described below. The controller 130 can direct whether or not the working fluid circuit 102 is operated and control a heating or cooling mode of the working fluid circuit 102, for example by controlling flow reverser 114 to direct flow from compressor 106 to first heat exchanger 108 in cooling modes and second heat exchanger 112 in heating modes. The controller 130 can further direct operation of control valves 124 to direct flow through the process fluid circuit 104 in accordance with the determined operating mode, and optionally further control operations of optional boiler 126 and/or optional cooling tower 128 to provide suitable temperatures of the process fluid.

FIGS. 2A-2E show a schematic of a heat pump system in various operating modes. Heat pump 200 includes working fluid circuit 202 including compressor 204, first heat exchanger 206, expander 208, and second heat exchanger 210. The heat pump further includes process fluid circuit 212 including process fluid economizer 214, radiative cooler 216, solar heater 218, boiler 220 and cooling tower 222. In an embodiment, second heat exchanger 210 and/or process fluid economizer 214 can be used to provide heating or cooling to air directed to a conditioned space.

In the mechanical cooling mode shown in FIG. 2A, the working fluid circuit 202 is operated using the first heat exchanger 206 as a condenser and second heat exchanger 210 as an evaporator. Process fluid circuit 212 is configured to circulate relatively hot process fluid from the condenser 206 to the radiative cooler 216, and direct relatively cool process fluid from the radiative cooler 216 to the first heat exchanger 206 after it has rejected heat at the radiative cooler 216. The second heat exchanger 210 can be used to provide cooling to a conditioned space.

FIG. 2B shows a schematic of the heat pump system in a hybrid cooling mode. In the hybrid cooling mode shown in FIG. 2B, the working fluid circuit 202 is operated in the cooling mode, using first heat exchanger 206 as a condenser and second heat exchanger 210 as an evaporator. In the process fluid circuit 212, process fluid is cooled at the radiative cooler 216 and then further cooled at cooling tower 222. The process fluid then is directed also to the first heat exchanger 206 of working fluid circuit 202 to accept heat rejected by use of the first heat exchanger 206 as a condenser in the operation of working fluid circuit 202. The second heat exchanger 210 is used to provide cooling to the conditioned space. The relatively hot process fluid leaving first heat exchanger 206 then flows to the radiative cooler 216 and cooling tower 222 to be cooled and continue to circulate through operation in the cooling mode as shown in FIG. 2B.

FIG. 2C shows a schematic of the heat pump system in a free cooling mode. In the free cooling mode shown in FIG. 2C, the working fluid circuit 202 is turned off or otherwise not in operation. The process fluid circuit 212 is configured to circulate process fluid from the process fluid economizer 214 to the radiative cooler 216 where the process fluid is cooled, and return the cool process fluid from the radiative cooler 216 to the process fluid economizer 214. Process fluid economizer 214 can be used to provide cooling.

FIG. 2D shows a schematic of the heat pump system in a hybrid heating mode. In the hybrid heating mode shown in FIG. 2D, working fluid circuit 202 is operated in a heating mode, with second heat exchanger 210 used as a condenser, receiving working fluid from compressor 204, and first heat exchanger 206 used as an evaporator to absorb heat from the process fluid. Working fluid circuit 202 thus operates as a heat pump in the hybrid heating mode. The process fluid circuit 212 circulates the process fluid between the first heat exchanger 206 and the solar heater 218, taking relatively cool process fluid from first heat exchanger 206, heating the process fluid at the solar heater 218, and returning the now heated process fluid to first heat exchanger 206 where the process fluid can serve as a source of heat for the heat pump operation of the working fluid circuit 202. The second heat exchanger 210 provides heating to the conditioned space. Optionally, boiler 220 can be used to heat the process fluid in addition to solar heater 218, for example to support the solar heater 218 when solar heater 218 is not sufficient to meet heating demand by itself. The boiler 220 can be in series with the solar heater 218, for example, being downstream of the solar heater 218. The boiler 220 can be configured to heat process fluid to a target temperature for the heating operation. The heating of the process fluid by boiler 220 can increase the temperature of the process fluid used as the source for the working fluid circuit 202, allowing the operation of the working fluid circuit 202 to in turn provide greater heating to the conditioned space.

FIG. 2E shows a schematic of the heat pump system in a free heating mode. In the free heating mode of FIG. 2E, working fluid circuit 202 is turned off or otherwise not in operation. The process fluid circuit 212 is configured to circulate process fluid from the process fluid economizer 214 to the solar heater 218 where the process fluid is heated, and return the heated process fluid from the solar heater 218 to the process fluid economizer 214. Process fluid economizer 214 can be used to provide heating.

FIG. 3 shows a flowchart of a method for determining an operating mode of a heat pump system according to an embodiment. Method 300 includes receiving temperature and/or optionally humidity data 302 and determining a cooling or heating mode 304. When the cooling mode is determined at 304, method 300 can further include determining an availability of free cooling at 306, performing free cooling at 308 when free cooling is available and determining if a cooling load is satisfied by free cooling at 310. Method 300 can include performing mechanical cooling at 312 if the cooling load is not satisfied by free cooling, or if free cooling is not available. During or following mechanical cooling at 312, it can be determined if the cooling load is satisfied at 314. If it is determined at 314 that the cooling load is not satisfied, hybrid cooling can be performed at 316.

When a heating mode is determined at 304, method 300 can further include performing free heating 318, determining if a heating load is satisfied by free heating at 320, and performing hybrid heating at 322 when the heating load is not satisfied by free heating.

Method 300 controls the operating mode of a heat pump system. Method 300 controls the selection of the operation of the heat pump system to meet the heating or cooling needs of a conditioned space using solar heating or radiative cooling as possible to reduce a reliance on mechanical cooling or heating or the use of boilers or cooling towers. The determinations made in method 300 can be made at one controller or at a plurality of controllers in communication with one another. The controllers performing method 300 can be connected to components of the heat pump system, such as compressors, flow reversers, control valves, sensors, and any other suitable components to determine the operating mode for the heat pump system and to operate the heat pump system in the determined mode.

Temperature and, optionally, humidity data, can be received at 302. The temperature data can include a temperature of the conditioned space and at least one of the temperature at a solar heater for a process fluid of the heat pump system or a temperature at a radiative cooler for the process fluid of the heat pump system. The temperature data can optionally further include ambient temperatures of the environment surrounding the conditioned space. Humidity data can optionally be received at 302. The humidity data can include a humidity in the conditioned space.

A cooling or heating mode can be determined at 304. In an embodiment, the cooling or heating mode can be determined by comparison of one or more temperatures in the conditioned space to a set point temperature, for example a set point temperature established by a user at a thermostat. When the temperature in the conditioned space is greater than the temperature in the conditioned space, it is determined at 304 for the operating mode to be a cooling mode. When the temperature in the conditioned space is less than the set point temperature, it is determined at 304 that the operating mode is to be a heating mode. In an embodiment, when the temperature in the conditioned space is at the set point temperature, the heat pump system can remain in a deactivated state or a maintenance state and the method can iterate by returning to receiving data at 302, for example for a discrete period of time or continuously, and the cooling or heating mode can be determined in a subsequent iteration or when the temperature of the conditioned space deviates from the set point temperature. In an embodiment, the determination of heating or cooling mode can further be based on humidity data such as humidity in the conditioned space. The humidity data can be used to adjust the temperature of the conditioned space or the set point temperature.

When a cooling mode is determined at 304, an availability of free cooling can be determined at 306. The availability of free cooling can be determined based on a temperature of process fluid at or leaving the radiative cooler. When the temperature of process fluid at or leaving the radiative cooler is lower than a set point temperature of the conditioned space, free cooling can be determined to be available. When the temperature of process fluid at or leaving the radiative cooler is at or greater than the set point temperature of the conditioned space, the radiative cooler alone is insufficient to provide cooling to the conditioned space, and a mechanical or hybrid cooling mode can be used instead, operating a working fluid circuit in a cooling mode to provide the desired cooling to the conditioned space.

Free cooling can be performed at 308. The free cooling at 308 can include cooling without operation of a mechanical cooling circuit, for example by circulating process fluid between a radiative cooler and a process fluid economizer, such that the process fluid economizer receives relatively cool process fluid, and relatively warm process fluid passes from the process fluid economizer to the radiative cooler to be cooled prior to again returning to the process fluid economizer as the relatively cool process fluid. The process fluid economizer can cool air being provided to the conditioned space(s).

It is determined if a cooling load is satisfied at 310. The determination of satisfaction of the cooling load at 310 can include comparison of a temperature of the conditioned space to a set point temperature. Optionally, the determination can further include calculation of a temperature required at the radiative cooler or at an inlet of the process fluid economizer needed to satisfy the cooling load based on the temperature of the conditioned space and optionally other characteristics of said conditioned space. In an embodiment, the determination of satisfaction of the cooling load at 310 can be made when a temperature of the conditioned space has stabilized following operation in the free cooling mode at 308.

When it is determined at 306 that free cooling cannot be performed or at 310 that the cooling load is not satisfied through free cooling, for example when a temperature of process fluid at the radiative cooler or entering the process fluid economizer is greater than the temperature of the conditioned space, mechanical cooling can instead be performed at 312. Mechanical cooling at 312 can be performed by operating the working fluid circuit of the heat pump system in a cooling mode, using a heat exchanger operating as an evaporator to provide cooling to the conditioned space and using the radiative cooler to cool process fluid that absorbs heat from the working fluid circuit. During or following the mechanical cooling at 312, it can be determined if the cooling load is satisfied at 314. When mechanical cooling at 312 does not satisfy the cooling load, the heat pump system can be operated in a hybrid cooling mode at 316 by operating a cooling tower in addition to the radiative cooler to cool the process fluid absorbing heat from the working fluid circuit, thereby increasing a cooling capacity of the working fluid circuit.

When the cooling load is determined to be satisfied at 310 or 314 or during or following hybrid cooling at 316, the method 300 can end, or return to the obtaining of temperatures at 302 to determine if heating or cooling may be required in a subsequent iteration of said method 300. Optionally, free cooling 308 or mechanical cooling 312 can be maintained at a level to offset heating of the conditioned space, for example due to the presence and/or actions of inhabitants, warm ambient temperatures, solar exposure, and the like.

When a heating mode is determined at 304, method 300 proceeds to performing free heating at 318. Performing free heating includes circulating relatively hot process fluid from a solar heater to the process fluid economizer, which is used to heat the conditioned space.

Following free heating at 318, it is determined whether free heating satisfies the heating load of the conditioned space at 320. The determination of satisfaction of the heating load at 320 can include comparison of a temperature of the conditioned space to a set point temperature. Optionally, the determination can further include calculation of a temperature required at the solar heater or at an inlet of the process fluid economizer needed to satisfy the cooling load based on the temperature of the conditioned space and optionally other characteristics of said conditioned space. In an embodiment, the determination of satisfaction of the heating load at 320 can be made when a temperature of the conditioned space has stabilized following operation in the free heating mode at 318.

When the heating load is determined to be satisfied at 320, or during or following hybrid heating at 322, the method 300 can end, or return to the obtaining of temperatures at 302 to determine if heating or cooling may be required in a subsequent iteration of said method 300. Optionally, free heating 318 can be maintained at a level to offset cooling of the conditioned space, for example due to cold ambient temperatures.

When it is determined that free heating has not satisfied the heating load of the conditioned space at 320, the heat pump system can be operated in a hybrid heating mode 322. In the hybrid heating mode, the working fluid circuit is operated in a heating mode, where a heat exchanger operates as a condenser to provide heat to the conditioned space. In the hybrid heating mode 322, process fluid is circulated from the solar heater to the heat exchanger of the working fluid circuit that is serving as the evaporator, to provide heat that can be pumped by the working fluid circuit to provide the heating at the heat exchanger operating as the condenser. The temperature of the process fluid can further be increased by a boiler, for example a boiler downstream of the solar heater and upstream of the heat exchanger being operated as the evaporator. The operation in the hybrid heating mode at 322 can continue until the heating load of the conditioned space is satisfied. In an embodiment, operation in the hybrid heating mode can be supplemented by using a boiler in series with the solar heater to provide additional heat to the process fluid being circulated, so as to further contribute heat to the process fluid economizer and also to the working fluid circuit by way of the heat exchanger operating as the evaporator.

### Aspects:

It is understood that any of aspects 1-8 can be combined with any of aspects 9-14.

Aspect 1. A heat pump system, comprising:
a working fluid circuit including:
   a compressor;
   a first heat exchanger;
   an expander; and
   a second heat exchanger;
a solar heater;
a radiative cooler;
   a process fluid economizer; and
a controller, configured to:
   determine an operating mode of the heat pump system, based on a temperature request, a current temperature, and one or both of a temperature of the process fluid at the solar heater and a temperature of the process fluid at the radiative cooler; and
   operate the heat pump system in the determined operating mode,
wherein the operating mode is selected from a set of operating modes comprising:
   a mechanical cooling mode wherein the working fluid circuit is operated to provide cooling at the second heat exchanger and wherein the process fluid absorbs heat at the first heat exchanger and rejects heat at the radiative cooler;
   a hybrid cooling mode wherein the working fluid circuit is operated to provide cooling at the second heat exchanger and wherein the process fluid absorbs heat at the first heat exchanger and rejects heat at the radiative cooler and at a cooling tower;
   a free cooling mode wherein the radiative cooler provides cooled process fluid to the process fluid economizer;
   a hybrid heating mode wherein the working circuit is operated to provide heating at the second heat exchanger and wherein the process fluid absorbs heat at the solar heater and rejects heat at the first heat exchanger; and
   a free heating mode wherein the solar heater provides heated process fluid to the process fluid economizer.

Aspect 2. The heat pump system according to aspect 1, wherein the cooling tower is configured to receive the process fluid from the radiative cooler.

Aspect 3. The heat pump system according to any of aspects 1-2, further comprising a boiler configured to receive process fluid from the solar heater, and wherein the hybrid heating mode includes operating the boiler to increase a temperature of the process fluid.

Aspect 4. The heat pump system according to any of aspects 1-3, wherein the controller is configured to determine the operating mode to be the mechanical cooling mode when the temperature request is less than the current temperature, and the temperature of the process fluid at the radiative cooler is greater than the temperature request.

Aspect 5. The heat pump system according to any of aspects 1-4, wherein the controller is configured to determine the operating mode to be the hybrid cooling mode when the temperature request remains less than the current temperature following operation in the free cooling mode.

Aspect 6. The heat pump system according to any of aspects 1-5, wherein the controller is configured to determine the operating mode to be the free cooling mode when the temperature request is less than the current temperature, and the temperature of the process fluid at the radiative cooler is less than the temperature request.

Aspect 7. The heat pump system according to any of aspects 1-6, wherein the controller is configured to determine the operating mode to be the hybrid heating mode when the temperature request is greater than the current temperature, and the temperature of the process fluid at the solar heater is less than the temperature request.

Aspect 8. The heat pump system according to any of aspects 1-7, wherein the controller is configured to determine the operating mode to be the free heating mode when the temperature request is greater than the current temperature, and the temperature of the process fluid at the solar heater is greater than the temperature request.

Aspect 9. A method for operating a heat pump system, comprising:
obtaining a temperature request;
obtaining a current temperature;
obtaining at least one of a temperature of a process fluid at a solar heater and a temperature of the process fluid at a radiative cooler;
determining an operating mode of the heat pump system based on the temperature request, the current temperature, and the at least one of the temperature of the process fluid at the solar heater and the temperature of the process fluid at the radiative cooler; and
operating the heat pump system in the determined operating mode, wherein the operating mode is selected from a set of operating modes comprising:
   a mechanical cooling mode wherein the working fluid circuit is operated to provide cooling at the second heat exchanger and wherein a process fluid absorbs heat at the first heat exchanger and rejects heat at the radiative cooler;
   a hybrid cooling mode wherein the working fluid circuit is operated to provide cooling at the second heat exchanger and wherein the process fluid absorbs heat at the first heat exchanger and rejects heat at the radiative cooler and at a cooling tower;
   a free cooling mode wherein the radiative cooler provides cooled process fluid to the process fluid economizer;
   a hybrid heating mode wherein the working circuit is operated to provide heating at the second heat exchanger and wherein the process fluid absorbs heat at the solar heater and rejects heat at the first heat exchanger; and
   a free heating mode wherein the solar heater provides heated process fluid to the process fluid economizer.

Aspect 10. The method according to aspect 9, wherein the operating mode is determined to be the mechanical cooling mode when the temperature request is less than the current temperature, and the temperature of the process fluid at the radiative cooler is greater than the temperature request.

Aspect 11. The method according to any of aspects 9-10, wherein the operating mode is determined to be the hybrid cooling mode when the temperature request remains less than the current temperature following operation in the free cooling mode.

Aspect 12. The method according to any of aspects 9-11, wherein the operating mode is determined to be the free cooling mode when the temperature request is less than the current temperature, and the temperature of the process fluid at the radiative cooler is less than the temperature request.

Aspect 13. The method according to any of aspects 9-12, wherein the operating mode is determined to be the hybrid heating mode when the temperature request is greater than the current temperature, and the temperature of the process fluid at the solar heater is less than the temperature request.

Aspect 14. The method according to any of aspects 9-13, wherein the operating mode is determined to be the free heating mode when the temperature request is greater than the current temperature, and the temperature of the process fluid at the solar heater is greater than the temperature request.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A heat pump system, comprising:
a working fluid circuit including:
a compressor;
a first heat exchanger;
an expander; and
a second heat exchanger;
a solar heater;
a radiative cooler;
a process fluid economizer; and
a controller, configured to:
determine an operating mode of the heat pump system, based on a temperature request, a current temperature, and one or both of a temperature of the process fluid at the solar heater and a temperature of the process fluid at the radiative cooler; and
operate the heat pump system in the determined operating mode,
wherein the operating mode is selected from a set of operating modes comprising:
a mechanical cooling mode wherein the working fluid circuit is operated to provide cooling at the second heat exchanger and wherein the process fluid absorbs heat at the first heat exchanger and rejects heat at the radiative cooler;
a hybrid cooling mode wherein the working fluid circuit is operated to provide cooling at the second heat exchanger and wherein the process fluid absorbs heat at the first heat exchanger and rejects heat at the radiative cooler and at a cooling tower;
a free cooling mode wherein the radiative cooler provides cooled process fluid to the process fluid economizer;
a hybrid heating mode wherein the working circuit is operated to provide heating at the second heat exchanger and wherein the process fluid absorbs heat at the solar heater and rejects heat at the first heat exchanger; and
a free heating mode wherein the solar heater provides heated process fluid to the process fluid economizer.

2. The heat pump system of claim 1, wherein the cooling tower is configured to receive the process fluid from the radiative cooler.

3. The heat pump system of claim 1, further comprising a boiler configured to receive process fluid from the solar heater, and wherein the hybrid heating mode includes operating the boiler to increase a temperature of the process fluid.

4. The heat pump system of claim 1, wherein the controller is configured to determine the operating mode to be the mechanical cooling mode when the temperature request is less than the current temperature, and the temperature of the process fluid at the radiative cooler is greater than the temperature request.

5. The heat pump system of claim 1, wherein the controller is configured to determine the operating mode to be the hybrid cooling mode when the temperature request remains less than the current temperature following operation in the free cooling mode.

6. The heat pump system of claim 1, wherein the controller is configured to determine the operating mode to be the free cooling mode when the temperature request is less than the current temperature, and the temperature of the process fluid at the radiative cooler is less than the temperature request.

7. The heat pump system of claim 1, wherein the controller is configured to determine the operating mode to be the hybrid heating mode when the temperature request is greater than the current temperature, and the temperature of the process fluid at the solar heater is less than the temperature request.

8. The heat pump system of claim 1, wherein the controller is configured to determine the operating mode to be the free heating mode when the temperature request is greater than the current temperature, and the temperature of the process fluid at the solar heater is greater than the temperature request.

9. A method for operating a heat pump system, comprising:
obtaining a temperature request;
obtaining a current temperature;
obtaining at least one of a temperature of a process fluid at a solar heater and a temperature of the process fluid at a radiative cooler;
determining an operating mode of the heat pump system based on the temperature request, the current temperature, and the at least one of the temperature of the process fluid at the solar heater and the temperature of the process fluid at the radiative cooler; and
operating the heat pump system in the determined operating mode,
wherein the operating mode is selected from a set of operating modes comprising:
a mechanical cooling mode wherein the working fluid circuit is operated to provide cooling at the second heat exchanger and wherein a process fluid absorbs heat at the first heat exchanger and rejects heat at the radiative cooler;
a hybrid cooling mode wherein the working fluid circuit is operated to provide cooling at the second heat exchanger and wherein the process fluid absorbs heat at the first heat exchanger and rejects heat at the radiative cooler and at a cooling tower;
a free cooling mode wherein the radiative cooler provides cooled process fluid to the process fluid economizer;
a hybrid heating mode wherein the working circuit is operated to provide heating at the second heat exchanger and wherein the process fluid absorbs heat at the solar heater and rejects heat at the first heat exchanger; and
a free heating mode wherein the solar heater provides heated process fluid to the process fluid economizer.

10. The method of claim 9, wherein the operating mode is determined to be the mechanical cooling mode when the temperature request is less than the current temperature, and the temperature of the process fluid at the radiative cooler is greater than the temperature request.

11. The method of claim 9, wherein the operating mode is determined to be the hybrid cooling mode when the temperature request remains less than the current temperature following operation in the free cooling mode.

12. The method of claim 9, wherein the operating mode is determined to be the free cooling mode when the temperature request is less than the current temperature, and the temperature of the process fluid at the radiative cooler is less than the temperature request.

13. The method of claim 9, wherein the operating mode is determined to be the hybrid heating mode when the temperature request is greater than the current temperature, and the temperature of the process fluid at the solar heater is less than the temperature request.

14. The method of claim 9, wherein the operating mode is determined to be the free heating mode when the temperature request is greater than the current temperature, and the temperature of the process fluid at the solar heater is greater than the temperature request.
